(19) United States
(12) Patent Application Publication
(10) Pub. No.: US 2021/0140369 A1
(43) Pub. Date: May 13, 2021

(54) LOW PRESSURE DIFFERENTIAL EJECTOR PUMP UTILIZING A LOBED, AXISYMMETRIC NOZZLE

(71) Applicant: The Boeing Company, Chicago, IL (US)

(72) Inventors: Carl King, Mesa, AZ (US); Kal V. Geiler, Mesa, AZ (US)

(73) Assignee: The Boeing Company, Chicago, IL (US)

(21) Appl. No.: 16/682,231

(22) Filed: Nov. 13, 2019

(51) Int. Cl. F02C 7/12

(52) U.S. Cl. CPC F02C 7/12; F05D 2260/20; F05D 2220/323

(57) ABSTRACT

An ejector including a mixing section; an inlet to the mixing section, the inlet comprising a first wall; a nozzle disposed in the inlet; the nozzle comprising the second wall defining a first channel through the nozzle, wherein the first wall and the second wall define a second channel through the inlet, the second wall has a trailing edge and a curved surface including a varying radius of curvature defining depressions extending to the trailing edge, a first flow of a first fluid into the second channel creates a pressure in the mixing section that draws a second flow of a second fluid through the first channel and into the mixing section, and the first flow and the second flow interact along the curved surface including the depressions and the trailing edge, forming a mixture comprising the first fluid and the second fluid. An outlet from the mixing section outputs the mixture, wherein the flow is well mixed and contains significant amounts of each fluid.

### BACKGROUND

### 1. Field

The present disclosure is related to ejectors and methods of making the same.

### 2. Description of the Related Art

FIG. 1A and FIG. 1B illustrate operation of a conventional ejector pump 100 including a motive nozzle 102, an inlet 104, a converging inlet nozzle 106, and a diverging outlet diffuser 116. Motive fluid 110 through the nozzle induces or sucks flow of ambient fluid 112 into the inlet and then into converging inlet nozzle. The ambient fluid and the motive fluid mix in the converging inlet nozzle to form a mixed fluid. The mixed fluid 118 is outputted from the ejector through the diffuser throat 114, the diverging outlet diffuser 116, and the outlet 120. The shape of the nozzle is configured to convert potential energy of the motive fluid to kinetic energy and the shape of the diffuser is configured to convert kinetic energy of the mixed fluid to potential energy. For proper operation, the ambient fluid sucked into the inlet has a pressure P1 and a velocity V1, the motive fluid has a pressure P2>P1 and velocity V2>V1, and the mixed fluid flowing out of the diverging outlet diffuser has a pressure P3>P1 and a velocity V3>V1.

Conventional ejectors may have insufficient pumping power at low pressure differentials and undesirably large dimensions for many pumping applications. Accordingly, there is a need for continued research and development efforts in the field of ejector systems. The present disclosure satisfies this need.

### SUMMARY

The present disclosure describes a novel ejector system. The ejector is embodied in many ways including, but not limited to, the following.

1. An ejector comprising a mixing section; an inlet to the mixing section, the inlet comprising a first wall; a nozzle disposed in the inlet; the nozzle comprising a second wall defining a first channel through the nozzle, wherein:
the first wall and the second wall define a second channel through the inlet,

the second wall has a trailing edge and a curved surface including a varying radius of curvature defining depressions extending to the trailing edge,

a first flow of a first fluid into the first channel creates a pressure in the mixing section that draws a second flow of a second fluid through the second channel and into the mixing section, and

the first flow and the second flow interact along the curved surface including the depressions and the trailing edge, forming a mixture comprising the first fluid and the second fluid; and

an outlet from the mixing section outputting the mixture, wherein the first flow and the second flow are mixed and contain at least 33% of each fluid.

2. The ejector of example 1, wherein the curved surface includes a plurality of lobes defined by the depressions.

3. The ejector of example 1, wherein the mixing section has a length L and a diameter D and the length is less than the diameter.

4. The ejector of example 3, wherein 0.1×D≤L≤D.

5. The ejector of example 3, wherein:

the trailing edge includes convex sections and concave sections, and

the trailing edge extending into the inlet such that −L≤X≤L, where X is a perpendicular distance from the beginning of the mixing section to the nearest point on the trailing edge of the nozzle.

6. An apparatus comprising the ejector and a gas turbine engine including an exhaust, wherein the exhaust is coupled to the ejector and the exhaust outputs the first fluid comprising exhaust gas to the nozzle.

7. A helicopter or airplane comprising the apparatus of example 6, wherein the gas turbine engine propels the helicopter or the airplane.

8. The apparatus of example 6, further comprising an auxiliary power unit comprising the gas turbine engine.

9. An aircraft comprising the apparatus of example 8.

10. An apparatus comprising a cooling system coupled to the ejector of example 1, wherein the second fluid comprises air used as a coolant in the cooling system.

11. An aircraft including the apparatus of example 10.

12. The ejector of example 1, wherein the outlet comprises a diffuser.

The present disclosure further describes a method of making an ejector. The method is embodied in many ways including, but not limited to, the following.

13. The method comprising:

providing a mixing section;

providing an inlet to the mixing section,

the inlet comprising a first wall; a nozzle disposed in the inlet; the nozzle comprising a second wall defining a first channel through the nozzle, wherein:
the first wall and the second wall define a second channel through the inlet,

the second wall has a trailing edge and a curved surface including a varying radius of curvature defining depressions extending to the trailing edge,

a first flow of a first fluid into the first channel creates a pressure in the mixing section that draws a second flow of a second fluid through the second channel and into the mixing section, and

the first flow and the second flow interact along the curved surface including the depressions and the trailing edge, forming a mixture comprising the first fluid and the second fluid; and

an outlet from the mixing section outputting the mixture, wherein the flow is mixed and contains at least 33% of each fluid.

14. The method of example 13, wherein the curved surface includes a plurality of lobes defined by the depressions.

15. The method of example 13, wherein the mixing section has a length L and a diameter D and the length is less than the diameter.

16. The method of example 15, wherein 0.1×D≤L≤D.

17. The method of example 15, wherein:

the trailing edge includes convex sections and concave sections, and

the trailing edge extending into the inlet such that −L≤X≤L, where X is a perpendicular distance from the beginning of the mixing section to the nearest point on the trailing edge of the nozzle.

18. The method of example 15, further comprising coupling the ejector to a gas turbine engine including an exhaust, wherein the exhaust is coupled to the ejector and the exhaust outputs the first fluid comprising exhaust gas to the nozzle.

19. The method of example 18, further comprising coupling the ejector to the gas turbine engine in a helicopter, wherein the gas turbine engine propels the helicopter.

20. The method of example 18, further comprising coupling the ejector to an auxiliary power unit comprising the gas turbine engine.

The present disclosure further describes a method of operating an aircraft, comprising:

providing an aircraft including a gas turbine engine outputting exhaust gas used to propel the aircraft;

providing the gas turbine engine coupled to a cooling system comprising coolant;

providing an ejector including:
a mixing section;
an inlet to the mixing section,
the inlet comprising a first wall; a nozzle disposed in the inlet; the nozzle comprising a second wall defining a first channel through the nozzle, wherein:
   the first wall and the second wall define a second channel through the inlet,
the second wall has a trailing edge and a curved surface including a varying radius of curvature defining depressions extending to the trailing edge,
a first flow of a first fluid into the first channel creates a pressure in the mixing section that draws a second flow of a second fluid through the second channel and into the mixing section, and
the first flow and the second flow interact along the curved surface including the depressions and the trailing edge, forming a mixture comprising the first fluid and the second fluid; and
an outlet from the mixing section outputting the mixture, wherein the flow is mixed and contains at least 33% of each fluid.

drawing the second fluid comprising the coolant through the ejector using the first flow comprising the exhaust gas so that the coolant is also drawn through the cooling system to cool a component on the aircraft.

### BRIEF DESCRIPTION OF THE DRAWINGS

FIGS. 1A and 1B illustrate a conventional ejector.

FIG. 2 illustrates a three dimensional view of an ejector according to an example described herein.

FIG. 3 is a cross-sectional view of the ejector illustrated in FIG. 2.

FIG. 4A illustrates an ejector coupled to an engine, according to one or more examples described herein.

FIG. 4B illustrates an ejector coupled to an engine in a helicopter, according to one or more examples described herein.

FIG. 4C illustrates a helicopter including the apparatus including the ejector coupled to the engine.

FIG. 5A illustrates an ejector coupled to an auxiliary power unit, according to one or more examples described herein.

FIG. 5B illustrates an ejector coupled to a cooling system, according to one or more examples described herein.

FIG. 5C illustrates an airplane including an ejector according to one or more examples described herein.

FIG. 6 is a flowchart illustrating a method of making an ejector.

FIG. 7 is a flowchart illustrating a method of operating an aircraft.

### DESCRIPTION

In the following description, reference is made to the accompanying drawings which form a part hereof, and which is shown, by way of illustration, several embodiments. It is understood that other embodiments may be utilized and structural changes may be made without departing from the scope of the present disclosure.

### Technical Description

The present disclosure describes an ejector including an inlet, a nozzle, a mixing section (e.g. mixing throat) and an outlet. The surface and/or the trailing edge of nozzle include a varying curvature that provides efficient induced flow pumping and a well-mixed total flow out of the outlet using a relatively short mixing section and/or a diffuser.

### Example Ejector Structure and Operation

FIG. 2 and FIG. 3 illustrate an ejector 200, including a mixing section 202; an inlet 204 to the mixing section 202; a nozzle 206 coupled to (e.g., disposed in) the inlet 204; and an outlet 208 from the mixing section. The inlet 204 comprises a first wall 210 and the nozzle 206 comprises a second wall 212 defining a first channel 214 through the nozzle. The first wall 210 and the second wall 212 define a second channel 216 through the inlet.

The second wall 212 has a trailing edge 218 and a curved surface 220 including a varying radius of curvature defining depressions 222 or surface channels extending to the trailing edge. The nozzle is coupled to the inlet so that a first flow 224 of a first fluid 226 into the first channel creates a pressure in the mixing section that draws a second flow 228 of a second fluid 230 through the second channel and into the mixing section. The first flow and the second flow interact along the curved surface including the depressions 222 and the trailing edge 218, so as to form a flow 231 comprising a mixture 232 comprising the first fluid and the second fluid. The outlet 208 from the mixing section outputs the mixture 232. The result is flow that is mixed and contains at least 33% of each fluid (e.g., at least 33% of the flow comprises the first fluid and at least 33% of the flow comprises the second fluid).

As illustrated herein, the curved surface 220 includes depressions (e.g., lowered regions between raised regions). In one example, the depressions result in the second channel having a height 234 (comprising a perpendicular distance from the first wall to the second wall) that varies according to position on the perimeter of the first wall. Examples of the curved surface include features or a curvature that increase a surface area of interaction between the curved surface and the first flow and/or the second flow, so as to generate turbulence and/or vortices in the first flow and/or the second flow that increase mixing of the first flow and the second flow. As illustrated herein, examples of the features include, but are not limited to, the second wall including a plurality of lobes 236 (e.g., defined by the depressions), corrugations, and/or scallops.

In various examples, the curvature of the curved surface increases mixing of the first flow and the second flow so as to enable a shorter mixing section. In one example, the mixing section has a length L and a diameter D (and L<D). In one or more examples, 0.1×D≤L≤D (where D is a constant diameter of the mixing section 202). Example cross-sections of the mixing section include, but are not limited to, a circular cross-section, a square cross-section, or a rectangular cross-section (in which case D is the largest width of the mixing section). The mixing section typically has a constant width or diameter D along its length L. As illustrated in FIG. 2, the second fluid flowing through the ejector flows first through a first section (the inlet) of the ejector having a decreasing cross section (decreasing diameter) moving in the direction of the second flow along the longitudinal axis 238 of the ejector, then a second section (the mixing section) having a constant cross-section (constant diameter), and then a third section (outlet) having an increasing cross-section (increasing diameter) moving in the direction of the second flow along the longitudinal axis.

In one or more further examples, the trailing edge includes a second curvature (e.g., an elongated linear edge) that increases mixing of the first flow and the second flow. Examples include, but are not limited to, the second curvature comprising scallops or having convex sections 240 and concave sections 242. In one example, the convex sections include an extremity extending to a furthest point into the mixing section. In one or more examples, the trailing edge 218 extends a distance into the inlet 204 such that −L≤X≤L, where X is the perpendicular distance from the beginning 248 of the mixing section 202 to the nearest point 244 on the trailing edge 218. In one or more examples, the ejector illustrated in FIG. 2 and including dimensions −L≤X≤L and 0.1×D≤L≤D results in significant and unexpected mixing of the first fluid and the second fluid as proportional to a conventional ejector wherein the mixing section has L in range of 6-10 times the diameter D.

In one or more examples, the inlet has a longitudinal axis 238 and the nozzle is disposed axi-symmetrically in the inlet about the longitudinal axis, so that both the nozzle and the inlet comprise cylindrical or circular cross-sections that are symmetric about the longitudinal axis 238. In one or more further examples, the mixing section also has a cylindrical or circular cross-sections about the longitudinal axis and the major width comprises a major diameter (or maximum diameter) of the mixing section. In one or more embodiments, the ejector having the nozzle disposed axi-symmetrically in the inlet produces significantly increased mixing of the first flow and the second flow, as compared to an ejector wherein the inlet has a two dimensional rectangular cross-section, the nozzle has a two dimensional rectangular cross-section.

### Example Applications

In various examples, the ejector is a passive device using the first flow of the first fluid to pump the second fluid through a system without the use of additional power such as a fan.

FIG. 4A and FIG. 4B illustrate an apparatus 400 comprising an engine 402 including an exhaust 404, wherein the exhaust is coupled to the ejector 200 so that the first fluid comprising the exhaust gas 406 is outputted from the exhaust into the nozzle. FIG. 4C illustrates an aircraft 408a comprising a helicopter 408 including the apparatus 400 and rotors 410, wherein the engine 402 (e.g., gas turbine engine 402a) powers the rotors 410 that propel the helicopter 408.

FIG. 5A illustrates an example wherein the apparatus 400 comprises an auxiliary power unit 412 comprising the engine coupled to the ejector, so that the first fluid includes exhaust gas outputted from the auxiliary power unit. In another example, the ejector is coupled to a cooling system, the second fluid comprises a coolant (e.g., air) used in the cooling system (e.g., air conditioning unit), and the first fluid pumps or circulates the coolant through the cooling system. FIG. 5B illustrates a cooling system 500 pumping coolant 502 to cool various aircraft systems. The cooling system is coupled to the apparatus 400 so that the first fluid comprising the exhaust gas 406 passing through the ejector draws the second fluid (comprising the coolant 502) through the ejector and the cooling system. FIG. 5C illustrates an airplane 504 including the apparatus 400 comprising the auxiliary power unit.

Process Steps

FIG. 6 is a flowchart illustrating a method of making an ejector.

Block 600 represents providing a mixing section (e.g., mixing throat). In one example, the mixing section has a length L and a diameter D (i.e., largest width) and L<D. In one or more examples, 0.1×D≤L≤D. In one or more examples, the ratio of L to D has a critical or large effect on mixing and how much ambient air is drawn through the inlet.

Block 602 represents coupling an inlet (e.g., plenum, re-entrant nozzle) to the mixing section, the inlet comprising a first wall. In various examples, the inlet has a bell mouth.

Block 604 represents disposing a nozzle in the inlet so that the nozzle includes a second wall defining a first channel through the nozzle. The second wall and the first wall also define a second channel through the inlet and the second channel has a height comprising a perpendicular distance from the first wall to the second wall. The second wall has a trailing edge and a curved surface including a varying radius of curvature defining depressions extending to the trailing edge.

In one or more further examples, the trailing edge also includes a second curvature that increases mixing of the first flow and the second flow. Examples include, but are not limited to, the second curvature having convex sections and concave sections, the convex sections including an extremity extending to a furthest point into the mixing section. In one or more examples, the trailing edge extends a distance into the inlet such that −L≤X≤L, where X is the perpendicular distance from the beginning of the mixing section to the nearest point on the trailing edge of the nozzle. In one or more examples, the ratio of X to L has a critical or large effect on mixing and how much ambient air is drawn through the inlet.

Block 606 represents coupling an outlet to the mixing section.

Block 608 represents the end result, a ejector. Dimension considerations include, but are not limited to, ratio of motive flow area to mixing area, design of the inlet (e.g., reentrant orifice), mixing length in the mixing section, diffusion angle of the mixture in the outlet, and nozzle plane orientation with respect to plane of the inlet (reentrant orifice).

Examples of the ejector include, but are not limited to, the following.

1. An ejector (200), comprising:

a mixing section (202);

an inlet (204) to the mixing section (202), the inlet (204) comprising a first wall (210);

a nozzle (206) disposed in the inlet (204); the nozzle (206) comprising a second wall (212) defining a first channel (214) through the nozzle (206), wherein:
the first wall (210) and the second wall (212) define a second channel (216) through the inlet (204),
the second wall (212) has a trailing edge (218) and a curved surface (220) including a varying radius of curvature defining a plurality of depressions (222) extending to the trailing edge (218),
a first flow (224) of a first fluid (226) into the first channel (214) creates a pressure in the mixing section (202) that draws a second flow (228) of a second fluid (230) through the second channel (216) and into the mixing section (202), and
the first flow (224) and the second flow (228) interact along the curved surface (220) including the depressions (222) and the trailing edge (218), forming a mixture (232) comprising the first fluid (226) and the second fluid (230); and

an outlet from the mixing section (202) outputting the mixture (232), wherein the flow is mixed and contains at least 33% of each fluid.

2. The ejector (200) of example 1, wherein the curved surface (220) includes a plurality of lobes (236) defined by the depressions (222).

3. The ejector (200) of examples 1 or 2, wherein the mixing section (202) has a length L and a diameter D and the length is less than the diameter.

4. The ejector (200) of example 3, wherein 0.1×D≤L≤D.

5. The ejector (200) of examples 3 or 4, wherein:

the trailing edge (218) includes convex sections (240) and concave sections (242), and:

the trailing edge (218) extends into the inlet such that −L≤X≤L, where X is the perpendicular distance from the beginning (248) of the mixing section (202) to the nearest point (244) on the trailing edge (218).

6. The ejector (200) of any of the preceding examples, wherein the depressions and trailing edge increase the interaction length between the first flow and the second flow, thereby increasing the efficiency of mixing of the first flow and the second flow and enabling a shorter mixing section as compared to the curved surface and the trailing edge without the varying radius of curvature.

7. The ejector (200) of any of the preceding examples, wherein the outlet comprises a diffuser.

8. A method of making an ejector (200), comprising:

providing a mixing section (202);

providing an inlet (104, 204) to the mixing section (202), the inlet (104, 204) comprising a first wall (210); and

a nozzle (206) disposed in the inlet (104, 204); the nozzle (206) comprising a second wall (212) defining a first channel (214) through the nozzle (206), wherein:
the first wall (210) and the second wall (212) define a second channel (216) through the inlet (204),
the second wall (212) has a trailing edge (218) and a curved surface (220) including a varying radius of curvature defining depressions (222) extending to the trailing edge (218),
a first flow (224) of first fluid (226) into the nozzle (206) creates a pressure in the mixing section (202) drawing a second flow (228) of second fluid (230) through the inlet (104, 204) and into the mixing section (202), and
the first flow (224) and the second flow (228) interact along the curved surface (220) including the depressions (222) and the trailing edge (218) forms a flow (231) comprising a mixture (232) comprising the first fluid (226) and the second fluid (230); and

providing an outlet (208) from the mixing section (202) outputting the mixture (232), wherein the flow is mixed and contains at least 33% of each fluid.

Block 610 represents optionally coupling the ejector to an application.

Examples include, but are not limited to, the following.

1. An apparatus (400) comprising the ejector (200) and a gas turbine engine (402) including an exhaust (404), wherein the exhaust (404) is coupled to the ejector (200) and the exhaust (404) outputs the first fluid (226) comprising exhaust (404) gas to the nozzle (206).

2. A helicopter (408) or airplane (504) comprising the apparatus (400) of example 5, wherein the gas turbine engine (402a) propels the helicopter (408) or the airplane (504).

3. The apparatus (400) of example 5, further comprising an auxiliary power unit (412) comprising the gas turbine engine (402a).

4. An aircraft (410) comprising the apparatus (400) of example 3.

5. An apparatus (400) comprising a cooling system (500) coupled to the ejector (200), wherein the second fluid (230) comprises air used as a coolant (502) in the cooling system (500).

6. An aircraft (410) including the apparatus (400) of example 5.

7. An apparatus of any of the preceding examples, further including a conduit (e.g., hose or pipe) is connected to the nozzle and the exhaust, wherein the conduit transports the first fluid comprising the exhaust gas to the nozzle.

8. A first apparatus outputting a first flow of the first fluid and a second apparatus outputting a second flow of a second fluid, wherein the first apparatus comprises an exhaust system on rotorcraft/aircraft, wherein the ejector is a passive device coupled to the first apparatus so as to dramatically reduce infrared signature of the exhaust gas outputted from the exhaust system. In such an example, the first flow comprising motive flow is outputted from the first apparatus comprising a turbine exhaust system, and the motive flow induces the second flow (comprising ambient, lower temperature air) into the mixing section and a diffuser. The mixture of the first flow and the second flow comprises a well-mixed total flow, or plume, that significantly reduces the temperature of the motive flow comprising high temperature exhaust gases outputted from the turbine exhaust system. The result is a compact, lightweight exhaust system that provides reduced infrared signature.

9. A first apparatus outputting a first flow of the first fluid and a second apparatus outputting a second flow of a second fluid, wherein the second apparatus comprises a cooling system that draws the second flow of coolant through the cooling system, and the first apparatus comprises an exhaust system or other source of first flow comprising the motive flow.

FIG. 7 is a flowchart illustrating a method of operating an aircraft (504a).

Block 700 represents providing an aircraft (408a) including a gas turbine engine (402a) outputting exhaust gas used to propel the aircraft.

Block 702 represents providing the gas turbine engine coupled to a cooling system comprising coolant.

Block 704 represents providing an ejector (200) according to any of the examples described herein including:
a mixing section (202);
an inlet (104, 204) to the mixing section (202), the inlet (104, 204) comprising a first wall (210) and
a nozzle (206) disposed in the inlet (104, 204); the nozzle (206) comprising a second wall (212) defining a first channel (214) through the nozzle (206), wherein:
the second wall (212) has a trailing edge (218) and a curved surface (220) including a varying radius of curvature defining depressions (222) extending to the trailing edge (218),
a first flow (224) of first fluid (226) into the nozzle (206) creates a pressure in the mixing section (202) drawing a second flow (228) of second fluid (230) through the inlet (104, 204) and into the mixing section (202), and
the first flow (224) and the second flow (228) interact along the curved surface (220) including the depressions (222) and the trailing edge (218) forms a flow (231) comprising a mixture (232) comprising the first fluid (226) and the second fluid (230); and
an outlet (208) from the mixing section (202) outputting the mixture (232), wherein the flow is mixed and contains at least 33% of each fluid (e.g., at least 33% of the flow comprises the first fluid and at least 33% of the flow comprises the second fluid).

Block 706 represents drawing the second fluid (230) comprising coolant (502) through the ejector (200) using the first flow (224) comprising exhaust gas (404) when the ejector (200) is coupled to the gas turbine engine (402a) outputting the exhaust gas (404) to the nozzle (206).

### Advantages and Improvements

While a conventional ejector as illustrated in FIG. 1 may be used to provide mixing and induced flow pumping, such an ejector system requires higher pressure differential between the flows and a longer mixing section to achieve the same efficiency (as compared to a lobed nozzle according to embodiments described herein). Active systems that mix the exhaust gas and ambient air with fans or other active pumping systems are less desirable because such active systems are generally more mechanically complicated and heavier.

An ejector according to embodiments described herein, on the other hand, provides superior mixing and induced flow pumping without any of the drawbacks of current methods. A lobed, axisymmetric nozzle can provide an order of magnitude more linear edge between the low and high pressures regions versus a traditional motive nozzle. This increased edge length leads to more vortex generation and ultimately more efficient mixing. The efficient mixing leads to a shorter more lightweight assembly that can significantly increase induced pumping and reduce infra-red signature.

### CONCLUSION

This concludes the description of the preferred embodiments of the present disclosure. The foregoing description of the preferred embodiment has been presented for the purposes of illustration and description. It is not intended to be exhaustive or to limit the disclosure to the precise form disclosed. Many modifications and variations are possible in light of the above teaching. It is intended that the scope of rights be limited not by this detailed description, but rather by the claims appended hereto.

What is claimed is:

1. An ejector, comprising:
a mixing section;
an inlet to the mixing section, the inlet comprising a first wall;
a nozzle disposed in the inlet; the nozzle including a second wall defining a first channel through the nozzle, wherein:
the first wall and the second wall define a second channel through the inlet,
the second wall has a trailing edge and a curved surface including a varying radius of curvature defining depressions extending to the trailing edge,
a first flow of a first fluid into the first channel creates a pressure in the mixing section that draws a second flow of a second fluid through the second channel and into the mixing section, and
the first flow and the second flow interact along the curved surface including the depressions and the trailing edge, forming a flow comprising a mixture comprising the first fluid and the second fluid; and
an outlet from the mixing section outputting the mixture, wherein the flow is mixed and contains at least 33% of each fluid.

2. The ejector of claim 1, wherein the curved surface includes a plurality of lobes defined by the depressions.

3. The ejector of claim 1, wherein the mixing section has a length L and a diameter D and the length is less than the diameter.

4. The ejector of claim 3, wherein 0.1×D≤L≤D.

5. The ejector of claim 3, wherein:
the trailing edge includes convex sections and concave sections, and
the trailing edge extending into the inlet such that −L≤X≤L, where X is a perpendicular distance from a beginning of the mixing section to a nearest point on the trailing edge of the nozzle.

6. An apparatus comprising the ejector of claim 1 and a gas turbine engine including an exhaust, wherein the exhaust is coupled to the ejector and the exhaust outputs the first fluid comprising exhaust gas to the nozzle.

7. A helicopter or airplane comprising the apparatus of claim 6, wherein the gas turbine engine propels the helicopter or the airplane.

8. The apparatus of claim 6, further comprising an auxiliary power unit comprising the gas turbine engine.

9. An aircraft comprising the apparatus of claim 8.

10. An apparatus comprising a cooling system coupled to the ejector of claim 1, wherein the second fluid comprises air used as a coolant in the cooling system.

11. An aircraft including the apparatus of claim 10.

12. The ejector of claim 1, wherein the outlet comprises a diffuser.

13. A method of making an ejector, comprising:
providing a mixing section;
providing an inlet to the mixing section, the inlet comprising a first wall; and
disposing a nozzle in the inlet; the nozzle comprising a second wall defining a first channel through the nozzle, wherein:
the first wall and the second wall define a second channel through the inlet,
the second wall has a trailing edge and a curved surface including a varying radius of curvature defining depressions extending to the trailing edge,
a first flow of first fluid into the nozzle creates a pressure in the mixing section drawing a second flow of second fluid through the inlet and into the mixing section, and
interaction of the first flow and the second flow along the curved surface including the depressions and the trailing edge forms a flow comprising a mixture comprising the first fluid and the second fluid; and
providing an outlet from the mixing section outputting the mixture, wherein the flow is mixed and contains at least 33% of each fluid.

14. The method of claim 13, wherein the curved surface includes a plurality of lobes defined by the depressions.

15. The method of claim 13, wherein the mixing section has a length L and a diameter D and the length is less than the diameter.

16. The method of claim 15, wherein 0.1×D≤L≤D.

17. The method of claim 15, wherein:
the trailing edge includes convex sections and concave sections, and
the trailing edge extending into the inlet such that −L≤X≤L, where X is a perpendicular distance from a beginning of the mixing section to the nearest point on the trailing edge of the nozzle.

18. The method of claim 13, further comprising coupling the ejector to a gas turbine engine including an exhaust, wherein the exhaust is coupled to the ejector and the exhaust outputs the first fluid comprising exhaust gas to the nozzle.

19. The method of claim 18, further comprising coupling the ejector to the gas turbine engine in a helicopter, wherein the gas turbine engine propels the helicopter.

20. A method of operating an ejector on an aircraft, comprising:
providing an aircraft including a gas turbine engine outputting exhaust gas used to propel the aircraft;
providing the gas turbine engine coupled to a cooling system comprising coolant; and
providing an ejector coupled to the gas turbine engine and the cooling system, the ejector including:
a mixing section;
an inlet to the mixing section, the inlet comprising a first wall
a nozzle disposed in the inlet; the nozzle comprising a second wall defining a first channel through the nozzle, wherein:
the first wall and the second wall define a second channel through the inlet, the second wall has a trailing edge and a curved surface including a varying radius of curvature defining depressions extending to the trailing edge,
a first flow of first fluid into the nozzle creates a pressure in the mixing section drawing a second flow of second fluid through the inlet and into the mixing section, and
the first flow and the second flow interact along the curved surface including the depressions and the trailing edge forming a flow comprising a mixture comprising the first fluid and the second fluid; and
an outlet from the mixing section outputting the mixture, wherein the flow is mixed and contains at least 33% of each fluid; and
drawing the second fluid comprising the coolant through the ejector using the first flow comprising the exhaust gas so that the coolant is also drawn through the cooling system to cool a component on the aircraft.
